(19) United States
(12) Patent Application Publication
(10) Pub. No.: US 2008/0211823 A1
(43) Pub. Date: Sep. 4, 2008

(54) Three-dimensional graphic accelerator and method of reading texture data

(75) Inventors: Young-Jin Chung, Seongnam-si (KR); Kil-Whan Lee, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/005,400

(22) Filed: Dec. 27, 2007

(30) Foreign Application Priority Data
Jan. 5, 2007 (KR) 10-2007-001508

(51) Int. Cl. G06T 15/00

(52) U.S. Cl. 345/552

(57) ABSTRACT

A three-dimensional (3D) graphic accelerator accessing an external memory storing a plurality of texture data is provided. The 3D graphic accelerator may include a texture cache storing the texture data, a geometry processing unit generating texture status information, and a texture processing unit generating a texture address to access the texture cache and outputting one or more texels from the texture data of the texture cache. The texture cache receives the texture address from the texture processing unit and generates a control signal for reading a part or all of a series of texture data from the external memory in accordance with the texture status information when a cache miss occurs.

### PRIORITY STATEMENT

This U.S. non-provisional patent application claims priority under 35 U.S.C. §119 of Korean Patent Application No. 2007-01508 filed on Jan. 5, 2007, the entire contents of which are incorporated herein by reference.

### BACKGROUND

Example embodiments relate to cache systems and more particularly, to a texture cache storing texture data.

With rapid advancement of hardware in electronic systems, PC-level data processing units are beginning to be operable in real-time rendering processes, and three-dimensional (3D) graphic systems are increasingly employed in various applications. Especially, texture mapping technology is employed in graphic systems and may provide more practical 3D images without increasing a quantity of arithmetic operations. Texture mapping is the technology for replacing pixel colors with texture image colors in graphic systems, rendering abstract objects more minute and realistic.

Textures mean surface graphics of 3D objects. Without textures, 3D objects are shown as bones of naked polygons. Textures add reality to an image. For example, brick walls, lizard skins, or metallic surfaces of space shuttles may be depicted using texture mapping. Three-dimensional programs store textures as graphic patterns and apply the texture in a structure of polygons.

Polygons refer to two-dimensional (2D) patterns (e.g., triangles or rectangles) used for creating 3D image objects. Generally, several hundred or thousand polygons are used in forming 3D object bones.

Generally, a texture mapping technique is operationally divided into a mapping operation for mapping a screen space into a texture space, and a filtering operation for determining pixel colors on the mapping region. One pixel of the texture space, which may be referred to as a texel does not necessarily correspond to one picture pixel. For example, there are two modes. In one mode, several texture pixels correspond to one picture pixel (e.g., scale-down). In another mode, one texture pixel corresponds to several picture pixels (e.g., magnification). In these cases, filtering is generally carried out to lessen an aliasing effect that would be generated. The filtering includes general techniques for enhancing qualities of textures (e.g., mapping sources) put on objects (e.g., polygons), in which the MIP (multum in parv; much in a small space) mapping technique is most widely used. The term ‘texel’ means an abbreviation of ‘texture element’. Texel generally refers to each of the pixels constituting a bitmap graphic used as a texture when pixels are applied to polygons.

FIG. 1 is a diagram illustrating a general configuration of a MIP map.

Referring to FIG. 1, after forming an image pyramid through reducing resolution by the rate of 1/4 with adopting an original texture data image (level 0) as a basic image, a MIP mapping operation is carried out using a MIP map with a size close to a polygon to be mapped. In conducting the MIP mapping operation, values of coordinates and levels for texture spaces are calculated, which correspond to picture pixels. The level values are typically defined by ratios between picture pixels and texture pixels. Continuously, two MIP maps are selected that are nearest the calculated level. Four pixel values nearest the texture coordinate are abstracted from each of the selected MIP maps. An average of the abstracted eight texture pixels (e.g., 2×4=8) is determined as a unit texture value. This process may be referred to as ‘tri-linear interpolation’.

The MIP mapping technique is most widely used in 3D graphic systems because the technique is useful in reducing image distortion and operable in an efficient mapping operation with a relatively small amount of data. As the mapping operation by level values on an image with various resolutions may provide a ratio between picture and texture pixels close to 1:1, the mapping operation may be relevant to memory access. For example, the MIP mapping may use and/or require eight texture pixels in mapping one pixel to a texture. Thus, in high-performance graphic systems, the texture mapping for picture pixels may use and/or require a memory bandwidth of about 2 Gb to 3 Gb per second and fast memory access, for example.

Software users may conduct a rendering process for a 3D image using textures with various formats and sizes. In general, 3D graphics are treated in a rendering process on a basis of polygons and rasterization is carried out by a scanning order in one polygon.

Rasterization refers to a process for transforming a graphic to a corresponding pixel pattern image.

A texture cache may conduct a line-filling operation with block-sized data that are fetched from a texture memory when there is a state of ‘cache miss’. But when there is a polygon edge or misalignment, a large amount texels are generally fetched even though only one or two of the texels are used for alignment. For example, as much as a block size of the texture cache may be fetched and then only one or two of the texels of the block size may be used for alignment. The remaining texels are usually replaced without any use.

### SUMMARY

Example embodiments are directed to a 3D graphic accelerator and texture reading method capable of reducing unnecessary memory access times.

Example embodiments are further directed to a 3D graphic accelerator and texture reading method capable of lowering a memory bandwidth.

Example embodiments are also directed to a 3D graphic accelerator and texture reading method capable of improving performance of texturing.

An example embodiment is directed to a 3D graphic accelerator accessing an external memory storing a plurality of texture data. The 3-dimensional graphic accelerator may include a texture cache storing the texture data; a geometry processing unit generating texture status information; and a texture processing unit generating a texture address to access the texture cache and outputting at least one texel from the texture data of the texture cache. According to an example embodiment, the texture cache receives the texture address from the texture processing unit, and generates a control signal for reading a part or all of a series of texture data, including the texture data designated by the texture address, from the external memory in accordance with the texture status information when a cache miss occurs.

According to an example embodiment, the texture cache determines the number of the series of texture data to be read from the external memory in accordance with the texture status information.

According to an example embodiment, the texture status information includes a texture format, a texture size, a polygon size, a rotation rate of polygon, and a texture filtering way.

According to an example embodiment, the texture cache fetches a part of the texture data after a cache miss address from a block of the external memory if a texture size is larger than a polygon size and the polygon rotates in a range between 0° and 180° when the cache miss occurs.

According to an example embodiment, a block of the texture cache contains the texture data in multiples of 16 texels.

According to an example embodiment, the texture cache fetches a part of the texture data before a cache miss address, including the cache miss address, from a block of the external memory if a texture size is larger than a polygon size and the polygon rotates in a range between 180° and 360° when the cache miss occurs.

According to an example embodiment, the texture cache controls a burst length and type for fetching a minimum amount of the texture data.

According to an example embodiment, the burst length is variable from 1 to a value capable of line-filling a block of the texture cache.

According to an example embodiment, the burst type is one of INCR and WRAP.

Another example embodiment provides a method of reading texture data in a 3D graphic accelerator having a texture cache and an external memory storing texture data. The method may include receiving texture status information and texture address; and generating a control signal for reading a series of texture data, including the texture data designated by the texture address, from the external memory in accordance with the texture status information when a cache miss occurs.

According to an example embodiment, the texture status information includes a texture format, a texture size, a polygon size, a rotation rate of polygon, and a texture filtering way.

According to an example embodiment, generating the control signal for reading a part of the texture data ranking after a cache miss address, including the cache miss address, from a block of the external memory if a texture size is larger than a polygon size and the polygon rotates in a range between 0° and 180° when the cache miss occurs.

According to an example embodiment, a block of the texture cache contains the texture data in multiples of 16 texels.

According to an example embodiment, generating the control signal is carried out by generating the control signal for reading a part of the texture data before a cache miss address, including the cache miss address, from a block of the external memory if a texture size is larger than a polygon size and the polygon rotates in a range between 180° and 360° when the cache miss occurs.

According to an example embodiment, the control signal controls a burst length and type for fetching a minimum volume of the texture data.

According to an example embodiment, the burst length is variable from 1 to a value capable of line-filling a block of the texture cache.

According to an example embodiment, the burst type is one of INCR and WRAP.

According to an example embodiment, the method further includes filtering the texture data.

According to an example embodiment, the method further includes determining the number of the series of texture data to be read from the external memory in accordance with the texture status information.

Still another example embodiment provides a texture cache. The texture cache may include a data fetch decider receiving texture status information and providing an index for fetching texture data from an external memory; a tag memory storing a tag memory address; a tag comparator receiving a texture address and tag memory address, comparing the texture address and tag memory address and generating a cache miss signal based on the comparison; a miss address generator receiving the cache miss signal and the index and generating the miss address based on the received cache miss signal and the index; and a burst-length and type controller receiving the index, cache miss signal and miss address and generating a control signal for reading a series of texture data from the external memory when a cache miss occurs.

Still another example embodiment provides a computer readable medium, which when by a processor, causes the processor to perform a method. The method includes receiving texture status information and texture address; and generating a control signal for reading a series of texture data, including the texture data designated by the texture address, from the external memory in accordance with the texture status information when a cache miss occurs.

### BRIEF DESCRIPTION OF THE FIGURES

Non-limiting and non-exhaustive example embodiments are described below with reference to the following figures, wherein like reference numerals refer to like parts throughout the various figures unless otherwise specified. In the figures:

FIG. 1 is a diagram illustrating a general configuration of MIP map;

FIG. 2 is a block diagram illustrating a schematic organization of a 3-domensional graphic system to which the present invention is applicable;

FIG. 3 is a block diagram illustrating a detailed structure of the texture processing unit shown in FIG. 1;

FIG. 4 is a block diagram illustrating a detailed structure of the texture processing unit shown in FIG. 1;

FIG. 5 is a diagram illustrating a signal function register (SFR) shown in FIG. 1;

FIG. 6 is a table illustrating concrete operations of a line filling policy by the data fetch decider shown in FIG. 4;

FIG. 7 is a diagram illustrating a structure of texture data stored in the data memory shown in FIG. 4; and

FIG. 8 is a flow chart arranging an operation of the 3-dimensional graphic system shown in FIG. 2.

### DETAILED DESCRIPTION OF EXAMPLE EMBODIMENTS

Various example embodiments will now be described more fully with reference to the accompanying figures. However, specific structural and functional details disclosed herein are merely representative for purposes of describing example embodiments, and one skilled in the art will appreciate that example embodiments may be embodied in many alternate forms and should not be construed as limited to only the embodiments set forth herein.

It should be understood that, although the terms first, second, etc. are used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a similar fashion (e.g., “between” versus “directly between”, “adjacent” versus “directly adjacent”, etc.).

The terminology used herein is for the purpose of describing example embodiments only and is not intended to be limiting of the example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments described below with respect to the figures are provided so that this disclosure will be thorough, complete and fully convey the concept of example embodiments to those skilled in the art. In the drawings, like numbers refer to like elements throughout.

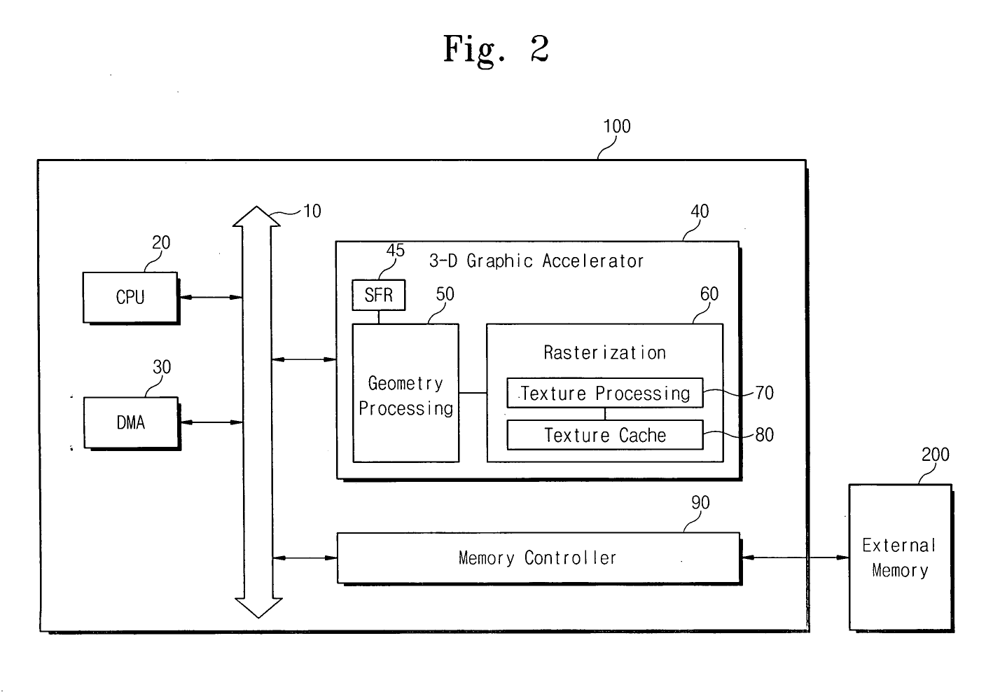

FIG. 2 is a block diagram illustrating a schematic organization of a 3D graphic system according to an example embodiment. In FIG. 2, there is shown an example embodiment of a 3D graphic system 100 as a system-on-chip (SOC) including a plurality of functional circuits integrated on a single chip.

Referring to FIG. 2, the example embodiment of the 3D graphic system 100 includes a system bus 10 and a plurality of bus masters and slaves commonly connected to the system bus 10. The bus masters control generation of address and control signals that are to be applied the system bus 30 at an operating point. The example bus masters shown in FIG. 2 are a central processing unit (CPU) 20, a direct memory access (DMA) block 30, and a 3D graphic accelerator 40. In FIG. 2, a memory controller 90 is an example of a bus slave.

The CPU 20 controls overall operation of the 3D graphic system 100. The DMA 30 functions to transfer data to a peripheral device, which is equipped in the 3D graphic system 100 without execution of program by the CPU 20. Because the CPU 20 is not directly involved in data transmission, overall performance of data transmission in the system may be enhanced. The 3D graphic accelerator 40 performs a 3D graphic processing operation. The 3D graphic technique represents a 3D object using three axes of height, width, and length, for example, and may depict the 3D image on a 2D monitor. The 3D graphic accelerator 40 shown in FIG. 2 includes a geometry processing unit 50, a rasterization unit 60, and a special function register (SFR) 45.

According to an example embodiment, the SFR 45 is a register for conducting a specific function, and stores the maximum size of a polygon and rotation information of a polygon.

According to an example embodiment, the geometry processing unit 50 conducts geometric conversion to covert and/or project an image to a 2D coordinate system from a 3D coordinate system.

According to an example embodiment, the rasterization unit 60 determines the final pixel values to be output into a picture relative to processed static points. The rasterization unit 60 conducts various kinds of filtering operations to provide a practical 3D image. For this function, the rasterization unit 60 includes a texture processing unit 70 and a texture cache 80 as shown in FIG. 2.

The texture processing unit 70 executes a texture filtering operation based on, for example, triangle information input from the geometry processing unit 50. Various kinds of texture data used in the texture filtering operation may exist in an external memory 200. The external memory 200 shown in FIG. 2 is located outside of the 3D graphic accelerator 40. The external memory 200 stores texture data. At least a portion of the texture data stored in the external memory 200 may be copied and stored in the texture cache 80 of the rasterization unit 60. The texture cache 80 may divisionally allocate its internal data storage space into a plurality of regions. The regions may function as a frame buffer, a Z-buffer, an alpha buffer, a stencil buffer, and a texture buffer. A series of data processing operations performed by the 3D dimensional graphic accelerator 40 may be referred to as a ‘graphics pipeline’. For the purpose of accelerating a speed of the graphics pipeline, the texture cache 80 is employed as an intermediate data storage medium between the texture processing unit 70 and the external memory 200. In this case, a hit ratio of the texture cache 80 becomes an important factor in determining a speed of the graphics pipeline.

In designing the texture cache 80 for rapidly conducting a texture mapping operation, an example embodiment of the texture cache 80 is configured to fetch only necessary texture data from the external memory without executing a line-filling operation by a predetermined block size when there is ‘cache miss’. Thus, the texture cache 80 according to an example embodiment may reduce a required bus bandwidth when there is a miss of texture cache and may enhance the performance of the 3D pipeline.

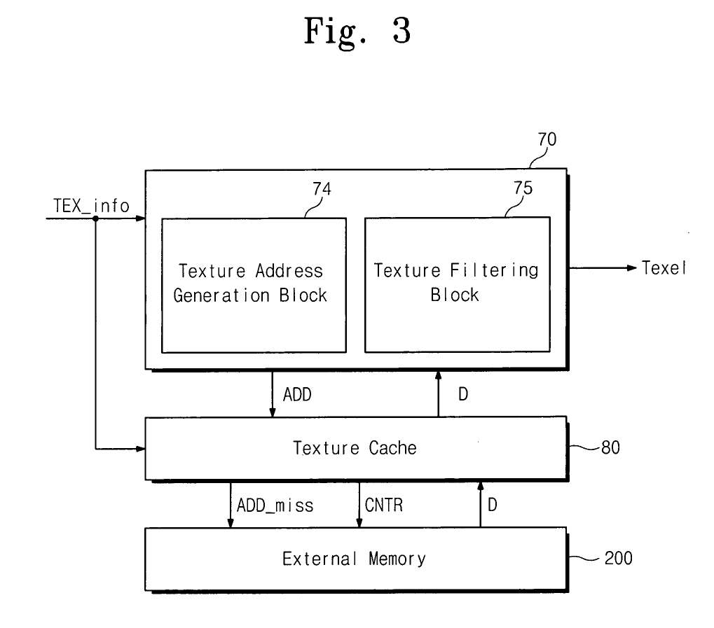

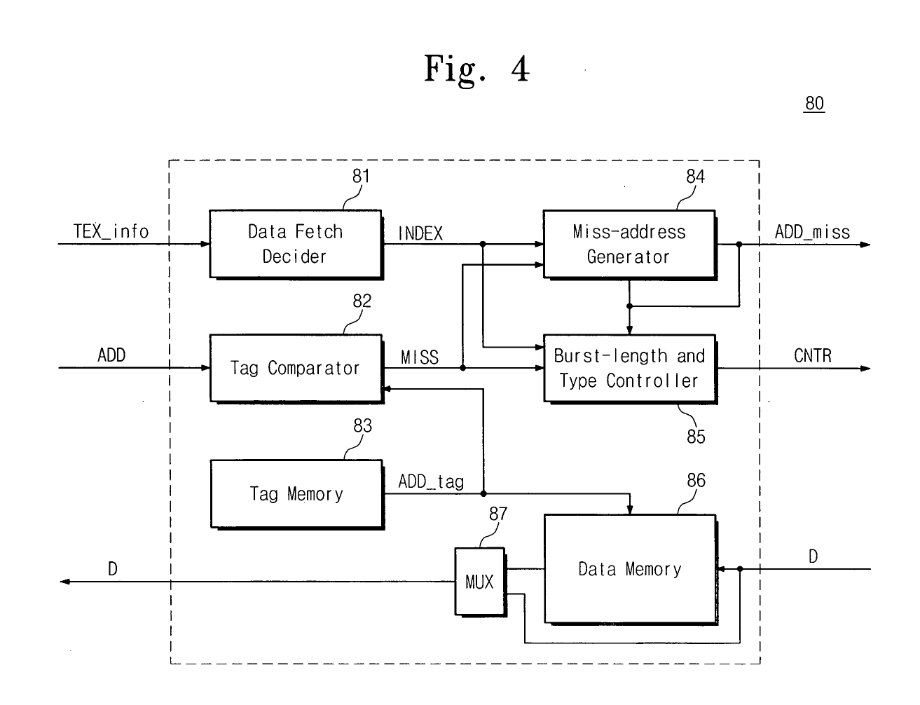

Detailed structures of the texture processing unit 70 and texture cache 80 according to an example embodiment are illustrated in FIGS. 3 and 4, respectively.

Referring to FIG. 3, the texture processing unit 70 includes a texture address generation block 74 and a texture filtering block 75.

Referring to FIGS. 2 and 3, the texture address generation block 74 receives texture status information TEX_info from the geometry processing unit 50. For example, the texture status information TEX_info includes a texture format, a texture size, a polygon size, polygon rotation information, and a texture filtering method.

The texture filtering block 75 receives texture data from the texture cache 80 and may conduct a bilinear or trilinear filtering operation, for example.

Filtering refers to an operation of utilizing pixel points on a single image, which conducts comparison between adjacent pixel values, adopts a filter to interpolate two pixel RGB values, and applies the pixel points to the pixels. An example of such a filtering operation is bilinear or trilinear filtering.

Bilinear filtering is a technique for making a texture less pixelized. This procedure may include creating the finally filtered pixels from RGB and four alpha texel values by way of interpolation and averaging processes.

Trilinear filtering is a technique for less pixelizing a texture, e.g., smoothing a texture. Trilinear filtering may include applying a bilinear filtering effect to two MIP maps on two texture planes. The finally filtered texture is re-filtered. As a texture is filtered three times, the operation is referred to as ‘trilinear filtering’. The trilinear filtering smoothly shows an integrated processing procedure or an overall object pattern.

Referring to FIGS. 3 and 4, an example embodiment of the texture cache 80 includes a data fetch decider 81, a tag comparator 82, a tag memory 83, a miss-address generator 84, a burst-length and type controller 85, and a data memory 86.

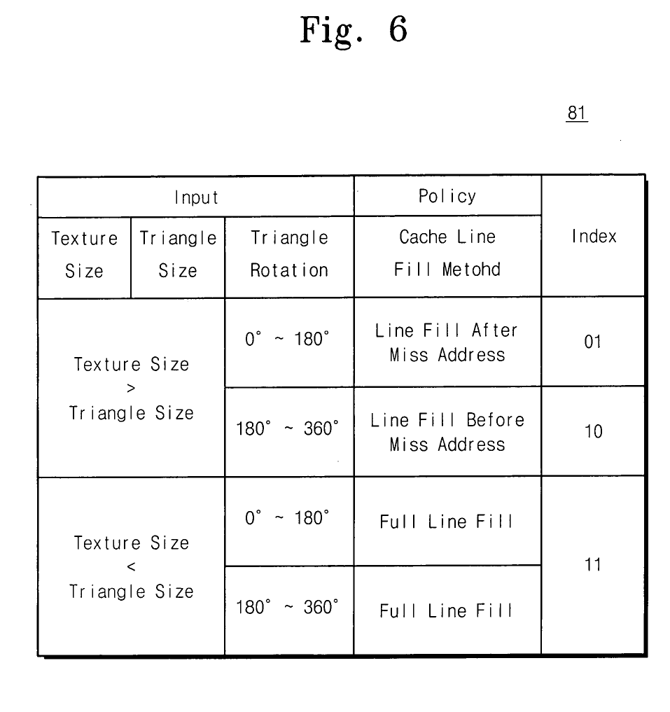

The data fetch decider 81 receives the texture status information TEX_info and then provides the miss-address generator 84 with a mode INDEX for fetching texture data from the external memory 200. The data fetch decider 81 may receive the texture status information TEX_info from the texture processing unit 70. The data fetch decider 81 determines how to store data in the data memory 86 when there is ‘cache miss’ while fetching texture data. A way of storing the data in the data memory 86 by the data fetch decider 81 will be detailed later in conjunction with FIG. 6.

‘Cache hit’ is used herein to refer to a case in which a texture to be processed is present in the data memory 86, while ‘cache miss’ is used herein to refer to a case in which a texture to be processed is absent in the data memory 86.

The texture cache 80 inputs an address (e.g., texture address) ADD received from the texture address generation block 74 to the tag comparator 82.

The tag comparator 82 compares the address ADD, which is received from the texture address generation block 74, with an address ADD_tag input from the tag memory 83. The address ADD received from the texture address generation block 74 and the address ADD_tag input received from the tag memory 83 are used to determine a ‘cache miss’ or ‘cache hit’.

If the address ADD received from the texture address generation block 74 and the address ADD_tag input received from the tag memory 83 do not match, the tag comparator 82 activates a cache miss signal MISS. The activated cache miss signal MISS is transferred to the miss-address generator 84 and the burst-length and type controller 85 as shown in FIG. 4.

According to an example embodiment, the external memory 200 stores texture data into the texture cache 80 in response to a control signal CTRL received from the burst-length and type controller 85. The texture data is transferred to the texture filtering block 75 through a multiplexer (MUX) 87.

If the address ADD received from the texture address generation block 74 and the address ADD_tag input received from the tag memory 83 do match, the tag comparator 82 deactivates the cache miss signal MISS.

According to an example embodiment, the data memory 86 transfers texture data D, which corresponds to the tag address ADD_tag provided from the tag memory 83, to the texture filtering block 75 through the MUX 87. The tag memory 83 stores the texture address ADD of the texture cache 80.

According to an example embodiment, the miss-address generator 84 operates to generate a miss address ADD_miss to access the external memory 200 when an activated ‘cache miss’ signal is received from the tag comparator 82.

According to an example embodiment, the burst-length and type controller 85 receives a control signal INDEX from the data fetch decider 81 and the cache miss signal MISS from the tag comparator 82, and then determines a burst length and type of the texture data D to be transferred from the external memory 200. The burst length and type of the texture data D may be determined based on the control signal INDEX and the cache miss signal.

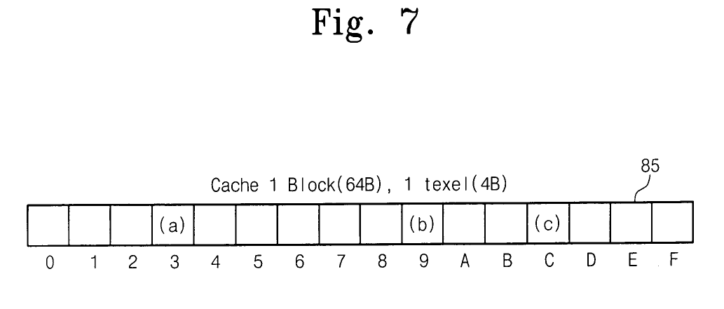

In generating the miss address ADD_miss and a burst length and type for line-filling the data memory 86, the texture cache 80 determines the burst length and type with reference to an address at which ‘cache miss’ occurs, and a fetching method set by the data fetch decider 81. A methodological feature for determining a burst length and type, which is to be transferred to the external memory 200, by the burst-length and type controller 85 is described below with respect to FIG. 7.

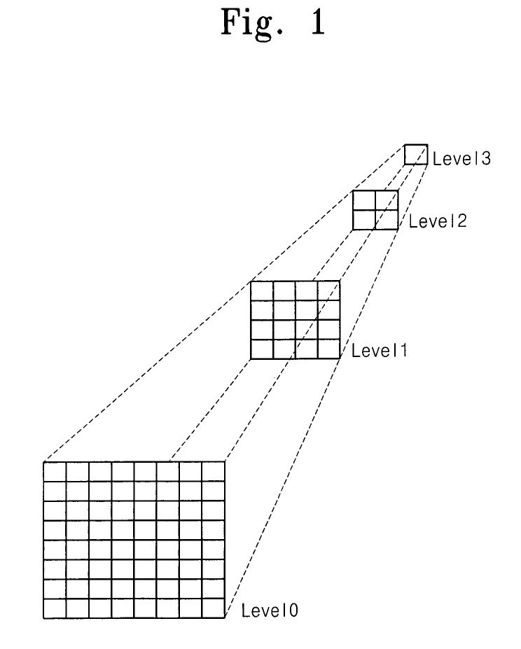

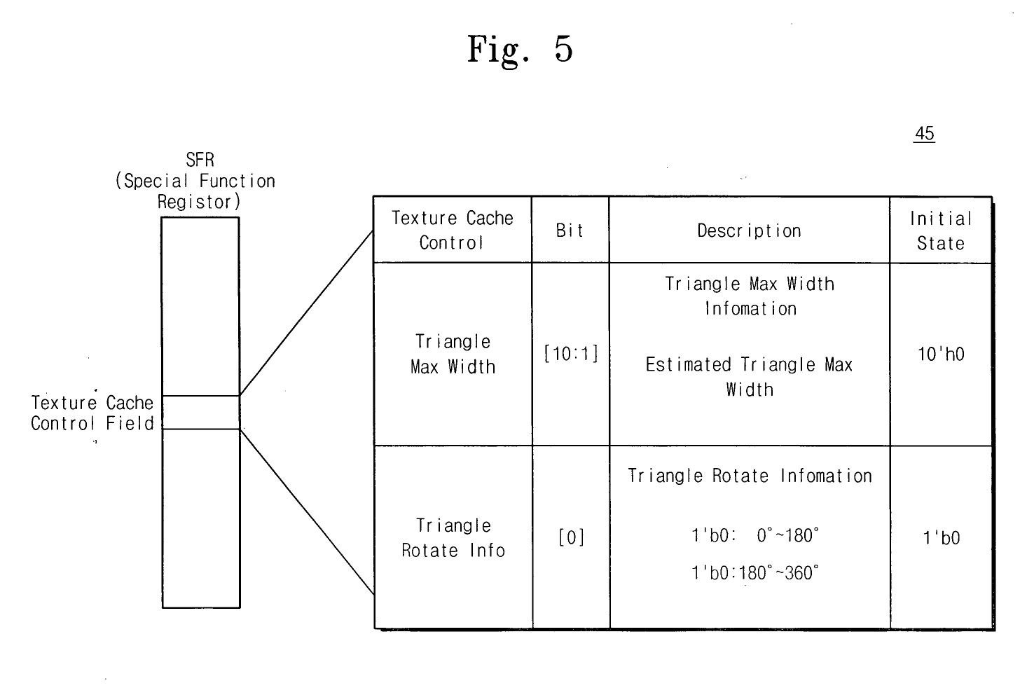

FIG. 5 is a diagram illustrating an example embodiment of a signal function register (SFR) 45 shown in FIG. 1. A programmer or a software user may set the SFR 45 using an external interface, for example.

Referring to FIG. 5, the SFR 45 stores the maximum polygon size and the polygon rotation information. The SFR 45 may provide the maximum polygon size and the polygon rotation information, e.g., the texture status information TEX_info, to the data fetch decider 81.

FIG. 6 is an example table representing an operation according to a line filling policy of the data fetch decider 81 shown in FIG. 4, and FIG. 7 is an example diagram illustrating a structure of texture data stored in the data memory 86 shown in FIG. 4.

According to an example embodiment, the data fetch decider 81 determines the line filling policy with reference to the texture status information TEX_info provided from the geometry processing unit 50. The texture status information TEX_info includes information about texture size, polygon size, and polygon rotation angle. Here, the polygon may be a triangle, for example.

In one example of the texture cache 80, a unit texel is 4 bytes and 16 texels forms a unit block. In this example, the texture cache 80 includes a plurality of blocks, each of which is 64 bytes in size.

The graphic system 100 is able to conduct the line-filling operation for one block in a time by means of ‘Burst 16’ assuming that a bus width of the graphic system 100 when line-filling one block of the texture cache 80.

According to FIGS. 2 through 7, a texture size is assumed to be larger than a triangle size. If the polygon (e.g., triangle) rotates in the range 0°˜180°, it is efficient for the line-filling operation of the data memory 86 to fetch the texture data D after generation of a miss address ADD_miss. Thus, the data fetch decider 81 transfers the control signal INDEX ‘01’ to the miss-address generator 84 and the burst-length and type controller 85.

Two kinds of burst modes, ‘INCR’ and ‘WRAP’, are discussed below with respect to example embodiments.

For example, ‘INCR Burst 8’ is the instruction for transferring data from a current address to ‘8’ by incrementing the current address in sequence. The number ‘8’ of ‘INCR Burst 8’ refers to a burst length.

A unit block of the data memory 86 may be divided into half blocks each corresponding to eight addresses. One half block corresponds with addresses from ‘0’ to ‘8’, and the other half block corresponds with addresses from ‘8’ to ‘F’. ‘WRAP Burst 8’ is the instruction for transferring data of a half block including a current address.

Stated differently, a burst length is variable from ‘1’ to the value capable of line-filling one block of the texture cache 80.

For example, if a position where a miss address is generated is an address (a), there are two ways of line-filling by assisting an unaligned burst transfer mode in the 3D graphic system 100. One way is to conduct the line-filling operation from the address (a) until the address ‘F’ in the burst mode INCR. The other way is to conduct the line-filling operation from the address (a)+1 until the address ‘F’ by means of an instruction ‘INCR Burst 12’ after first line-filling data of the address (a).

The unaligned burst transfer mode refers to a system capable of executing a burst operation from a predetermined address.

As another example, if a position where a miss address is generated is an address (b), there are two ways of line-filling by assisting the unaligned burst transfer mode in the 3D graphic system 100. One way is to conduct the line-filling operation from the address (b) until the address ‘F’ in the burst mode INCR. Another way is to conduct the line-filling operation from the address (b)−1 until the address ‘F’ by means of an instruction ‘INCR Burst 8’.

As still another example, if a position where a miss address is generated is an address (c), there is a way of line-filling by from the address (c) until the address ‘F’ using an instruction ‘INCR Burst 4’.

In a condition that a texture size is larger than a triangle size, if the triangle (e.g., polygon) rotates in the range 180°˜360°, it is efficient for the line-filling operation of the data memory 86 to fetch the texture data D before generation of a miss address. Thus, the data fetch decider 81 transfers the control signal INDEX ‘10’ to the miss-address generator 84 and the burst-length and type controller 85.

For example, contrary to a general case, it is likely for texture data, which ranks before a miss address, to be used in sequence when ‘cache miss’ occurs. Thus, during the line-filling operation, texture data before a miss address is fetched with reference to the information TEX_info of polygon rotation that is provided from the SFR 45.

The data fetch decider 81 operates to determine a data fetch method with reference to information of the SFR 45 and a texture size used by the texture processing unit when ‘cache miss’ occurs, and transfers a result of the determination to the miss-address generator 84 and the burst-length and type selector 85.

If a position where a miss address occurs is the address (a), there is a way of line-filling by using an instruction ‘WRAP Burst 4’, for example.

If a position where a miss address occurs is the address (b), there is a line-filling way of using an instruction ‘INCR Burst 2’ from the address (b)−1 and then using an instruction ‘WRAP Burst 8’ from the address (b)−2, for example.

Now, examples are described in which an assumption is made that a texture size is smaller than a triangle size. Under this condition, the line-filling operation for the data memory 86 is carried out by fetching the texture data D for all lines regardless of a rotation angle of triangle. Therefore, the data fetch decider 81 transfers the control signal INDEX ‘11’ to the miss-address generator 84 and the burst-length and type controller 85.

In texturing with small texture bricks on a large polygon, one kind of texture is used on the polygon many times. Thus, it is likely that data before a miss address may be used for the next time. In this case, a cache hit rate is raised by fetching data as large as a block size of the texture cache 80. At least in part, for this reason, example embodiments offer a feature of accepting estimated information of polygon size from a software user and selectively using a line-filling method in accordance with a texture size (considering the MIP map) to be used, in order to prevent texturing performance from degrading.

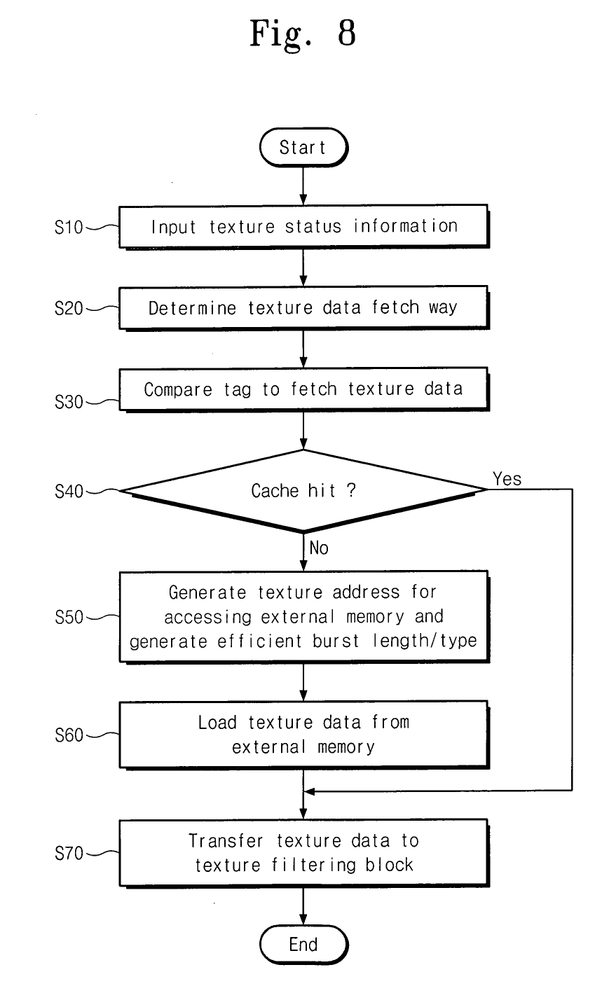

FIG. 8 is a flow chart arranging an example operation of the 3D graphic system 100 shown in FIG. 2.

Referring to FIGS. 2 through 8, in a step S10, the data fetch decider 81 receives the texture status information TEX_info from the geometry processing unit 50.

In operation S20, the data fetch decider 81 determines a way of storing texture data in the data memory 86 from the external memory 200.

In operation S30, the tag comparator 82 operates to compare the texture address ADD, which is used to fetch texture data, with the address ADD_tag stored in the tag memory 83.

In operation S40, the tag comparator 82 determines a current status as ‘cache miss’ or ‘cache hit’. If a ‘cache hit’ is determined, the method shown in FIG. 8 proceeds to operation S70. If a ‘cache miss’ is determined, the method shown in FIG. 8 proceeds to operation S50.

In operation S50, the miss-address generator 84 outputs the texture address ADD_miss for accessing the external memory 200. The burst-length and type controller 85 sets efficient values of burst length and type for transferring the texture data D from the external memory 200.

In operation S60, the data memory 86 receives the texture data D from the external memory 200.

In operation S70, the texture filtering block 75 conducts a filtering operation from receiving the texture data D.

According to example embodiments, when there is a miss on the texture cache, the texture cache 80 determines a way of fetching the texture data from the external memory and determines a burst length and type proper to the way of fetching the texture data.

Therefore, a memory bandwidth for the texturing operation may be reduced, which may improve the texturing performance by reduction of a memory access time according to example embodiments.

Example embodiments of the 3D graphic system described above may reducing memory bandwidth for texture and improve texturing performance by having shorter memory access time.

Further, various components of the above described 3D graphic system may be processors or microprocessors programmed according to the teachings of the above-described example embodiments, as will be apparent to those skilled in the computer art. Appropriate software or executable instructions can readily be prepared by programmers of ordinary skill based on the teachings of this disclosure and stored on various forms of well-known computer readable media.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A three-dimensional (3D) graphic accelerator accessing an external memory storing a plurality of texture data, comprising:
a texture cache storing the texture data;
a geometry processing unit generating texture status information; and
a texture processing unit generating a texture address to access the texture cache and outputting at least one texel from the texture data of the texture cache,
wherein the texture cache receives the texture address from the texture processing unit, and generates a control signal for reading a part or all of a series of texture data, including the texture data designated by the texture address, from the external memory in accordance with the texture status information when a cache miss occurs.

2. The 3D graphic accelerator as set forth in claim 1, wherein the texture cache determines the number of the series of texture data to be read from the external memory in accordance with the texture status information.

3. The 3D graphic accelerator as set forth in claim 1, wherein the texture status information includes a texture format, a texture size, a polygon size, a rotation rate of polygon, and a texture filtering way.

4. The 3D graphic accelerator as set forth in claim 3, wherein the texture cache fetches a part of the texture data after a cache miss address from a block of the external memory if a texture size is larger than a polygon size and the polygon rotates in a range between 0° and 180° when the cache miss occurs.

5. The 3D graphic accelerator as set forth in claim 4, wherein a block of the texture cache contains the texture data in multiples of 16 texels.

6. The 3D graphic accelerator as set forth in claim 3, wherein the texture cache fetches a part of the texture data before a cache miss address from a block of the external memory if a texture size is larger than a polygon size and the polygon rotates in a range between 180° and 360° when the cache miss occurs.

7. The 3D graphic accelerator as set forth in claim 6, wherein a block of the texture cache contains the texture data in multiples of 16 texels.

8. The 3D graphic accelerator as set forth in claim 3, wherein the texture cache controls a burst length and type for fetching a minimum volume of the texture data.

9. The 3D graphic accelerator as set forth in claim 8, wherein the burst length is variable from 1 to a value capable of line-filling a block of the texture cache.

10. The 3D graphic accelerator as set forth in claim 8, wherein the burst type is one of INCR and WRAP.

11. A method of reading texture data in a three-dimensional graphic accelerator having a texture cache and an external memory storing texture data, the method comprising:
receiving texture status information and texture address; and
generating a control signal for reading a series of texture data, including the texture data designated by the texture address, from the external memory in accordance with the texture status information when a cache miss occurs.

12. The method as set forth in claim 11, wherein the texture status information includes a texture format, a texture size, a polygon size, a rotation rate of polygon, and a texture filtering manner.

13. The method as set forth in claim 12, wherein generating the control signal includes generating the control signal for reading a part of the texture data after a cache miss address from a block of the external memory if a texture size is larger than a polygon size and the polygon rotates in a range between 0° and 180° when the cache miss occurs.

14. The method as set forth in claim 13, wherein a block of the texture cache contains the texture data in multiple of 16 texels.

15. The method as set forth in claim 12, wherein generating the control signal includes generating the control signal for reading a part of the texture data before a cache miss address from a block of the external memory if a texture size is larger than a polygon size and the polygon rotates in a range between 180° and 360° when the cache miss occurs.

16. The method as set forth in claim 15, wherein a block of the texture cache contains the texture data in multiples of 16.

17. The method as set forth in claim 11, wherein the control signal controls a burst length and type for fetching a minimum volume of the texture data.

18. The method as set forth in claim 17, wherein the burst length is variable from 1 to a value capable of line-filling a block of the texture cache.

19. The method as set forth in claim 17, wherein the burst type is one of INCR and WRAP.

20. The method as set forth in claim 11, further comprising:
filtering the texture data.

21. The method as set forth in claim 11, further comprising:
determining the number of the series of texture data to be read from the external memory based on the texture status information.

22. A texture cache comprising:
a data fetch decider receiving texture status information and providing an index for fetching texture data from an external memory;
a tag memory storing a tag memory address;
a tag comparator receiving a texture address and tag memory address, comparing the texture address and tag memory address and generating a cache miss signal based on the comparison;
a miss address generator receiving the cache miss signal and the index and generating the miss address based on the received cache miss signal and the index; and
a burst-length and type controller receiving the index, cache miss signal and miss address and generating a control signal for reading a series of texture data from the external memory when a cache miss occurs.

23. A computer readable medium, which when by a processor, causes the processor to perform a method comprising:
receiving texture status information and texture address; and
generating a control signal for reading a series of texture data, including the texture data designated by the texture address, from the external memory in accordance with the texture status information when a cache miss occurs.
